(19) United States
(12) Patent Application Publication
(10) Pub. No.: US 2023/0317979 A1
(43) Pub. Date: Oct. 5, 2023

(54) FUEL CELL, SYSTEM COMPRISING A FUEL CELL AND METHOD FOR CONTROLLING THE SYSTEM

(71) Applicant: SAFRAN POWER UNITS, Toulouse (FR)

(72) Inventors: Rémi André Armand STEPHAN, Moissy-Cramayel (FR); Théophile HORDE, Moissy-Cramayel (FR); Loïc Pierre Michel RIOS, Moissy-Cramayel (FR)

(73) Assignee: SAFRAN POWER UNITS, Toulouse (FR)

(21) Appl. No.: 18/040,754

(22) PCT Filed: Jul. 28, 2021
(86) PCT No.: PCT/FR2021/051405

§ 371 Date: Feb. 6, 2023

(30) Foreign Application Priority Data
Aug. 7, 2020 (FR) FR2008349

(51) Int. Cl. H01M 8/04029; H01M 8/04082; H01M 8/04223; H01M 8/04746; H01M 8/04701; H01M 8/1213

(52) U.S. Cl. CPC H01M 8/04029; H01M 8/04201; H01M 8/04268; H01M 8/04768; H01M 8/04753; H01M 8/04731; H01M 8/1213

(57) ABSTRACT

Fuel cell including a stack of membrane/electrodes assemblies, an inlet end plate and an outlet end plate, n intermediate plates disposed in the stack between the inlet and outlet end plates to form n+1 sub-stacks of the stack, n being greater than or equal to 1. The fuel cell may include ducts for circulating a heat transfer fluid, an oxidant and a fuel passing in the inlet and outlet end plates and the n intermediate plates, valves that may control the heat transfer fluid in the circulation ducts, and valves that may control the heat transfer fluid, the oxidant, and the fuel in the circulation ducts of the n intermediate plates and may be configured to allow circulation of the heat transfer fluid, the oxidant, and the fuel in m sub-stacks of the stack, m being greater than or equal to 1 and less than or equal to n.

### TECHNICAL FIELD

The present disclosure relates to a fuel cell including a system for heating the fuel cell, particularly a proton exchange membrane fuel cell.

### PRIOR ART

The fuel cells generally comprise a stack of elementary cells, also called stack, disposed between two current collectors. Each elementary cell is composed of a membrane/electrodes assembly, formed of a proton exchange membrane disposed between an anode electrode and a cathode electrode. The membrane/electrodes assembly is itself disposed between two distribution plates, also called bipolar plates. During the stacking of the elementary cells, the distribution plates disposed between two membrane/electrodes assemblies allow the circulation of hydrogen on one of their faces and of air on the opposite face.

Each fuel cell has an optimum operating temperature which depends on the nature of the various components forming the fuel cell. Also, in order to guarantee an optimum operation as well as a maximum lifetime of the fuel cell, it is recommended that the fuel cell can be maintained at a temperature close to this optimum temperature and this, in a homogeneous manner in the stack.

However, during its operation, the electrochemical reaction taking place within each elementary fuel cell is an exothermic reaction so that, if it is desired to maintain the temperature of the fuel cell at a temperature close to the optimum operating temperature, it is advantageous to cool the fuel cell.

In a known manner, the device for cooling the fuel cell comprises a coolant circulation pump which increases the space requirement of the fuel cell and which consumes energy.

Furthermore, in order to initiate the electrochemical reaction and quickly maximize the energy efficiency of the fuel cell, the stack of the fuel cell is preheated to the optimum operating temperature of the fuel cell which is generally higher than the ambient temperature, or even greater than 100° C. (degree Celsius), in particular in the case of a Proton Exchange Membrane Fuel Cell High Temperature, called PEMFC HT. This preheating can be carried out by means of an electrical resistance which is powered by a battery.

It is therefore understood that it is known to perform the preheating function by means of a heating device and the cooling function by means of a cooling device, separate from the heating device. These two devices are arranged in the fuel cell. Although such an arrangement allows regulating the temperature of the fuel cell, it implies in particular a significant increase in mass and space requirement of the fuel cell. Furthermore, the heating device may require a battery whose mass may be around 60 kg (kilogram).

### DISCLOSURE OF THE INVENTION

The present disclosure aims to overcome at least partly these drawbacks.

To this end, the present disclosure relates to a fuel cell including:
a stack of membrane/electrodes assemblies including an ion-conductive electrolyte disposed between an anode and a cathode, two adjacent assemblies being separated by a bipolar plate, the stack including a first and a second end,
an inlet end plate disposed at the first end of the stack and an outlet end plate disposed at the second end of the stack,
n intermediate plates disposed in the stack between the inlet end plate and the outlet end plate to form n+1 sub-stacks of the stack, n being greater than or equal to 1
ducts for circulating a heat transfer fluid, an oxidant and a fuel in the fuel cell, the circulation ducts passing in the inlet end plate, the outlet end plate and the n intermediate plates,
valves for controlling the heat transfer fluid in the circulation ducts of the outlet end plate and valves for controlling the heat transfer fluid, the oxidant and the fuel in the circulation ducts of the n intermediate plates, the control valves being configured to allow the circulation of the heat transfer fluid, the oxidant and the fuel in m sub-stacks of the stack, m being greater than or equal to 1 and less than or equal to n.

By “end plate of the fuel cell”, it is meant a plate allowing the mechanical clamping of the stack and including the fluid interfaces of the fuel cell.

It is understood that the circulation circuits also pass in the bipolar plates.

Thanks to the n intermediate plates, it is possible to form n+1 sub-stacks, and therefore not to preheat the entire stack of the fuel cell but m sub-stacks, m being greater than or equal to 1 and less than or equal to n. Then, when the m sub-stacks are at working temperature of the fuel cell, it is possible to generate electrical energy in the m sub-stacks and to use this energy to preheat other sub-stacks. Also, the energy required to preheat the entire stack is reduced compared to a fuel cell devoid of intermediate plates.

It is also possible to operate the fuel cell in idle mode in which the powers provided by the fuel cell are relatively low, the energy provided by the m sub-stacks being used, for example, to power auxiliary components of a system including the fuel cell and/or to charge a battery of the system and/or to provide the energy to a low-power consumer.

In idle mode, it is therefore not necessary to stop the complete stack. This allows quickly regaining power when desired. Indeed, in idle mode, part of the stack is maintained at working temperature of the fuel cell and the fuel cell may provide a maximum power more quickly than when the fuel cell has been stopped and therefore cooled.

In some embodiments, the ducts for circulating the heat transfer fluid for the preheating of the fuel cell and for the cooling of the fuel cell may be combined.

It is understood that it is possible to use the same heat transfer fluid to preheat the fuel cell during the phase of preheating the fuel cell and to cool the fuel cell during the phase of producing energy with the fuel cell.

It is understood that it is not necessary to provide separate ducts for circulating the heat transfer fluid during the preheating phase and during the energy production phase.

In some embodiments, the ion-conductive electrolyte may be a proton exchange membrane.

In some embodiments, the proton exchange membrane may be a proton exchange membrane high temperature.

In some embodiments, the valves for controlling at least one of the n intermediate plates may be external to the intermediate plate.

In some embodiments, at least one of the control valves may be provided with a check valve.

The present disclosure also relates to a system including a fuel cell as defined above, a circuit for circulating the heat transfer fluid, a circuit for circulating the fuel, a circuit for circulating the oxidant and an electric circuit including a device for storing energy.

In some embodiments, the energy storage device may include a battery, a supercapacitor, or any other device for storing energy.

In some embodiments, the heat transfer fluid circulation circuit may include a heat exchanger configured to cool the heat transfer fluid and a heat exchanger configured to heat the heat transfer fluid.

The present disclosure also relates to a method for controlling a system as defined above, the method including the following steps:
a step of preheating m sub-stacks of the stack of the fuel cell;
when the m sub-stacks are at working temperature, a step of producing energy in the m sub-stacks.

In some embodiments, the method may include:
a step of preheating p sub-stacks of the stack of the fuel cell at least partially by means of the energy and/or the heat produced by the m sub-stacks, the p sub-stacks being separate from the m sub-stacks and p being greater than or equal to 1 and m+p being less than or equal to n+1,
when the p sub-stacks are at working temperature, a step of producing energy in the m+p sub-stacks.

In some embodiments, the energy produced by the m sub-stacks may be stored in the energy storage device and/or be used to power auxiliary components of the system and/or be used to power components external to the system (600).

### BRIEF DESCRIPTION OF THE DRAWINGS

Other characteristics and advantages of the object of the present disclosure will emerge from the following description of embodiments, given by way of non-limiting examples, with reference to the appended figures.

FIG. 1 is a schematic view of a plurality of membrane/electrodes assemblies, two adjacent assemblies being separated by a bipolar plate.

FIG. 2 is a schematic view of a fuel cell of the state of the art.

FIG. 3 is a schematic view of a fuel cell according to the present disclosure.

FIG. 4 is a schematic view of another fuel cell according to the present disclosure.

FIG. 5 is a schematic view of an exemplary system according to the present disclosure.

FIG. 6 is a schematic view of examples of the circulation of the heat transfer fluid in the fuel cell of FIG. 3.

FIG. 7 is a schematic view of examples of the circulation of the fuel in the fuel cell of FIG. 3.

FIG. 8 is a schematic view of examples of the circulation of the oxidant in the fuel cell of FIG. 3.

FIG. 9 is a flowchart representing the steps of a method for controlling the system of FIG. 5.

In all the figures, the elements in common are identified by identical numerical references.

### DETAILED DESCRIPTION

In what follows, the elements common to the different embodiments are identified by the same numerical references.

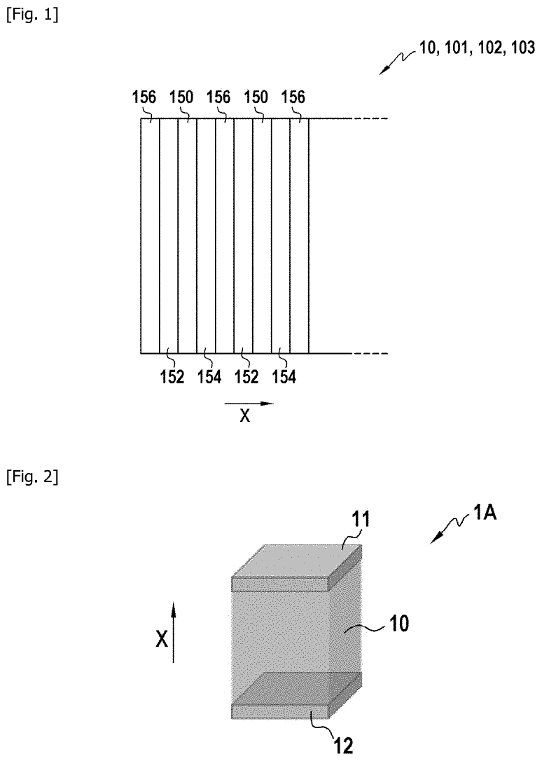

FIG. 1 is a schematic view of a plurality of membrane/electrodes assemblies 150-154, two adjacent assemblies 150-154 being separated by a bipolar plate 156. Each assembly 150-154 includes an ion-conductive electrolyte 150 disposed between an anode 152 and a cathode 154. The arrow X represents the direction of circulation of the fluids in the stack 10.

By way of non-limiting example, the ion-conductive electrolyte 150 may be a proton exchange membrane, for example a proton exchange membrane high temperature.

FIG. 2 represents a schematic view of a fuel cell 1A of the state of the art.

The fuel cell 1A of FIG. 2 includes a stack of membrane/electrodes assemblies 10 and a first and a second end. The fuel cell 1A of FIG. 2 includes an inlet end plate 12 disposed at the first end of the stack 10 and an outlet end plate 11 disposed at the second end of the stack 10. The arrow X represents the direction of circulation of the fluids in the fuel cell 1A.

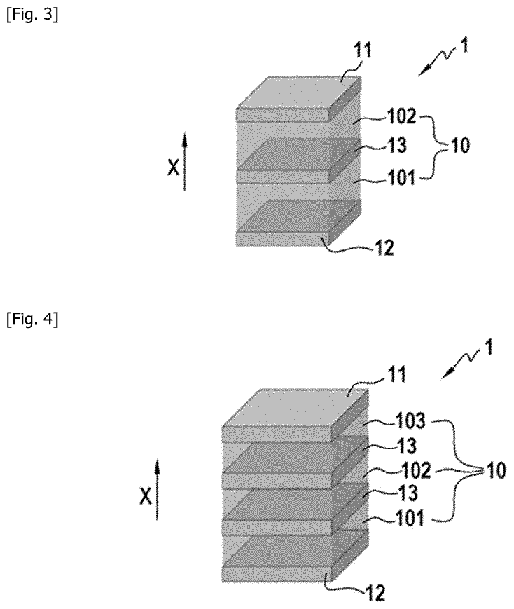

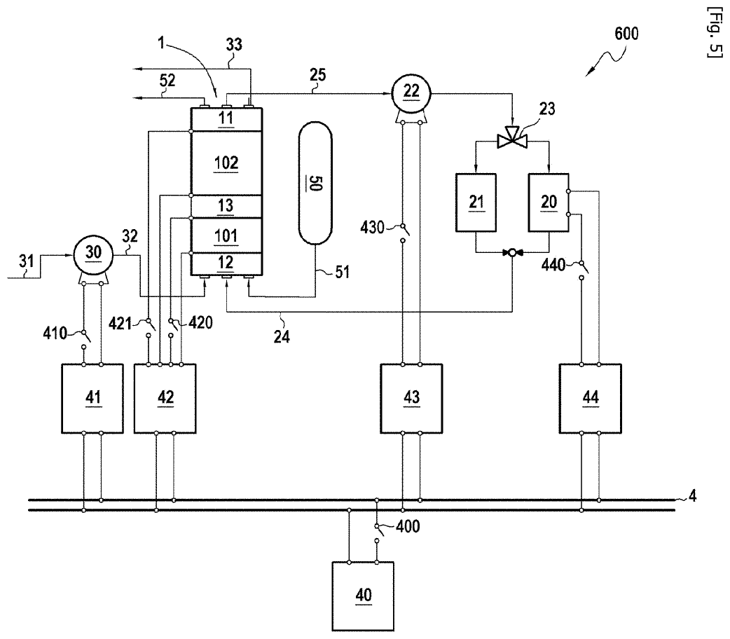

FIGS. 3 and 4 are schematic views of a fuel cell 1 according to the present disclosure.

The fuel cell 1 of FIGS. 3 and 4 includes a stack of membrane/electrodes assemblies 10 and a first and a second end. The fuel cell 1 of FIG. 3 includes an inlet end plate 12 disposed at the first end of the stack 10 and an outlet end plate 11 disposed at the second end of the stack 10. The stack 10 is defined between the inlet end plate 12 and the outlet end plate 11. The arrow X represents the direction of circulation of the fluids in the fuel cell 1.

In the embodiment of FIG. 3, the fuel cell 1 includes an intermediate plate 13, n being equal to 1. The intermediate plate 13 is disposed in the stack 10 between the inlet end plate 12 and the outlet end plate 11 to form two sub-stacks 101, 102 (n+1).

In the embodiment of FIG. 4, the fuel cell 1 includes two intermediate plates 13, n being equal to 2. The two intermediate plates 13 are disposed in the stack 10 between the inlet end plate 12 and the outlet end plate 11 to form three sub-stacks 101, 102, 103 (n+1).

It is understood that the present disclosure is not limited to a stack 10 including one or two intermediate plates 13. The stack may include n intermediate plates 13 which form n+1 sub-stacks of the stack 10.

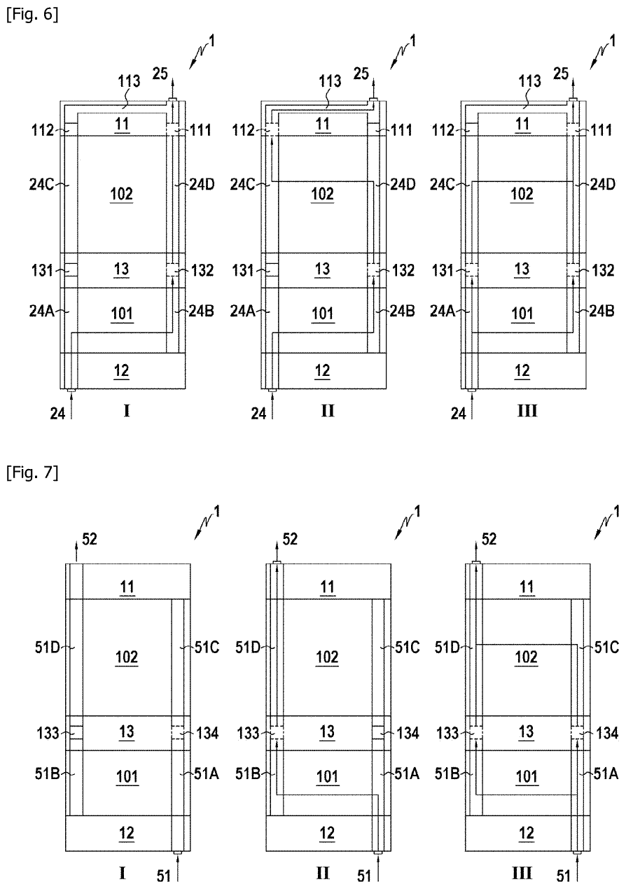

FIGS. 6-8 are respectively schematic views of the circulation of a heat transfer fluid, a fuel and an oxidant in the fuel cell 1 of FIG. 3.

FIG. 6 is a schematic view of the heat transfer fluid circulation ducts 24A-24D, 113 which pass in the inlet end plate 12, the outlet end place 11 and the intermediate plate 13. The fuel cell 1 includes valves for controlling the heat transfer fluid 111, 112 in the ducts of the outlet end plate 11 and valves for controlling the heat transfer fluid 131, 132 in the circulation ducts of the intermediate plate 13. The duct 113 is in the outlet end plate 11 for connecting the control valves 111 and 112. The control valve 131 is disposed between the duct 24A of the first sub-stack 101 and the duct 24C of the second sub-stack 102. The control valve 132 is disposed between the duct 24B of the first sub-stack 101 and the duct 24D of the second sub-stack 102. The control valve 112 is disposed between the duct 24C of the second sub-stack 102 and the duct 113 of the outlet end plate 11. The control valve 111 is disposed between the duct 24D of the second sub-stack 102 and the duct 113 of the outlet end plate 11.

In the embodiment of FIG. 6, the heat transfer fluid circulation ducts 24A-24D, 113 allow heating and cooling the fuel cell 1. The heat transfer fluid circulation ducts to preheat the fuel cell 1 are combined with the heat transfer fluid circulation ducts to cool the fuel cell 1.

It is understood that the fuel cell 1 may include separate ducts for circulating the heat transfer fluid for the preheating of the fuel cell 1 and for circulating the heat transfer fluid for the cooling of the fuel cell 1.

FIG. 7 is a schematic view of the fuel circulation ducts 51A-51D which pass in the inlet end plate 12, the outlet end plate 11 and the intermediate plate 13. The fuel cell 1 includes valves for controlling the fuel 133, 134 in the circulation ducts of the intermediate plate 13. The control valve 133 is disposed between the duct 51B of the first sub-stack 101 and the duct 51D of the second sub-stack 102. The control valve 134 is disposed between the duct 51A of the first sub-stack 101 and the duct 51C of the second sub-stack 102.

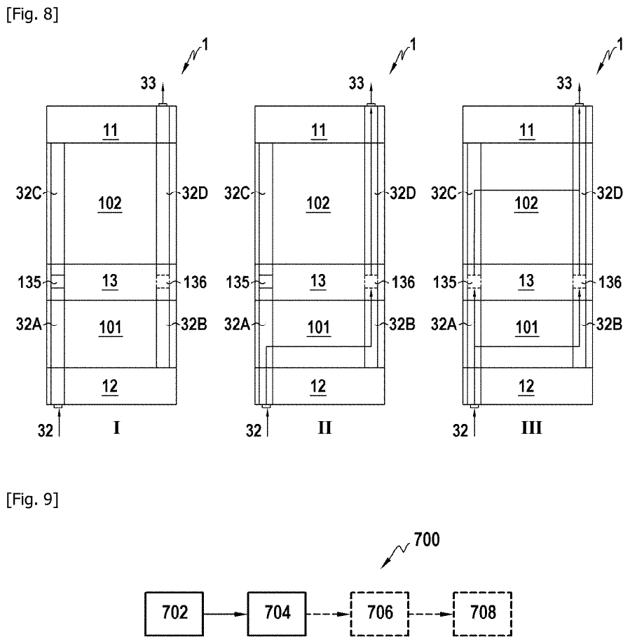

FIG. 8 is a schematic view of the oxidant circulation ducts 32A-32D which pass in the inlet end plate 12, the outlet end plate 11 and the intermediate plate 13. The fuel cell 1 includes valves for controlling the oxidant 135, 136 in the circulation ducts of the intermediate plate 13. The control valve 135 is disposed between the duct 32A of the first sub-stack 101 and the duct 32C of the second sub-stack 102. The control valve 136 is disposed between the duct 32B of the first sub-stack 101 and the duct 32D of the second sub-stack 102.

In the embodiment of FIGS. 6-8, the valves for controlling the heat transfer fluid 111, 112, 131, 132, the fuel 133, 134 and the oxidant 135, 136 are configured to allow the circulation of the heat transfer fluid, the oxidant and the fuel in m sub-stacks 101, 102, m being greater than or equal to 1 and less than or equal to n.

In the embodiment of FIGS. 6-8, m may be equal to 1 or 2, that is to say the control valves are configured to allow the circulation of the heat transfer fluid, the oxidant and the fuel in a single sub-stack 101 or in both sub-stacks 101, 102.

By way of non-limiting example, the heat transfer fluid may be oil or water.

By way of non-limiting example, the oxidant may be air or pure oxygen.

In the embodiment of FIGS. 6-8, the control valves are included in the intermediate plate 13.

It is understood that some control valves could not be included in the intermediate plate 13, that is to say some control valves may be external to the intermediate plate 13.

FIG. 5 represents a system 600 including a fuel cell 1, by way of non-limiting example, the fuel cell 1 of FIGS. 3, 6-8. It is understood that the system 600 may include a fuel cell including more than one intermediate plate 13.

In the embodiment of FIG. 5, the system 600 includes a circuit for circulating the heat transfer fluid 20-25, a circuit for circulating the oxidant 30-33 and a circuit for circulating the fuel 50-52.

In the embodiment of FIG. 5, the system 600 includes a heat exchanger 20 configured to heat the heat transfer fluid, by way of non-limiting example an electric heater and a heat exchanger 21 configured to cool the heat transfer fluid. The heat exchanger 20 configured to heat the heat transfer fluid and the heat exchanger 21 configured to cool the heat transfer fluid form part of the heat transfer fluid circulation circuit 20-25.

In the embodiment of FIG. 5, the heat transfer fluid circulation circuit 20-25 includes an inlet duct 24 for the entry of the heat transfer fluid into the fuel cell 1 and an outlet duct 25 for the exit of the heat transfer fluid from the fuel cell 1, a pump 22 for circulating the heat transfer fluid and a three-way valve 23 making it possible to orient the heat transfer fluid coming from the fuel cell 1 either towards the heat exchanger 20 configured to heat the heat transfer fluid, or towards the heat exchanger 21 configured to cool the heat transfer fluid. The heat transfer fluid inlet duct 24 is connected to the inlet end plate 12 of the fuel cell 1 and the heat transfer fluid outlet duct 25 is connected to the outlet end plate 11 of the fuel cell 1.

In the embodiment of FIG. 5, the pump 22 and the valve 23 are disposed in the heat transfer fluid outlet duct 25, between the fuel cell 1 and the heat exchangers 20, 21.

In operation of the fuel cell 1, the heat transfer fluid circulates in a loop in the heat transfer fluid circulation circuit 20-25. For example, the heat transfer fluid circulates in the fuel cell 1, that is to say in the heat transfer fluid circulation ducts 24A-24D, 113, leaves the fuel cell, circulates in the heat transfer fluid outlet duct 25, passes in the pump 22. At the outlet of the pump 22, depending on the ways open in the valve 23, the heat transfer fluid circulates in the heat exchanger 20 configured to heat the heat transfer fluid or in the heat exchanger 21 configured to cool the heat transfer fluid. At the outlet of the heat exchanger 20 or 21, the heat transfer fluid circulates in the heat transfer fluid inlet duct 24 and enters the fuel cell 1.

In the embodiment of FIG. 5, the fuel circulation circuit 50-52 includes a hydrogen tank 50, an inlet duct 51 for the entry of the hydrogen into the fuel cell 1 and an outlet duct 52 for the exit of the unconsumed hydrogen from the fuel cell 1. It is understood that the hydrogen tank 50 may be replaced by a fuel gas source containing hydrogen which may supply the fuel cell 1. The hydrogen inlet duct 51 is connected to the inlet end plate 12 of the fuel cell 1 and the unconsumed hydrogen outlet duct 52 is connected to the outlet end plate 11 of the fuel cell 1.

The hydrogen may be stored in the hydrogen tank 50 in liquid (cryogenic) or gaseous form under high pressure.

By way of non-limiting example, the hydrogen tank 50 is connected to the fuel cell 1, if necessary, via one or several devices for vaporizing the hydrogen and lowering its pressure (pressure reducing valves) to an adequate value for the fuel cell 1, for example a few bars, typically 1 to 2 bars absolute.

There are mainly 2 modes of supplying the fuel cell with gaseous hydrogen: “circulating” or “dead-end” mode.

In the “circulating” mode, a flow control valve is disposed upstream of the fuel cell 1 so as to provide to the fuel cell 1 the necessary hydrogen flow rate as a function of the electricity production of the fuel cell 1. The flow rate is provided with a certain surplus and the proportion of unconsumed hydrogen is discharged through the outlet duct 52.

In the “dead end” mode, a valve is disposed on the outlet duct 52. This valve is closed most of the time. The fuel cell 1 is supplied directly with hydrogen at the correct pressure, without flow control device. Only the hydrogen necessary for the fuel cell 1 is consumed in the fuel cell, which tends to decrease the hydrogen pressure in the fuel cell 1. The supply device maintains the desired hydrogen pressure in the fuel cell 1 and therefore allows supplying the fuel cell 1 with hydrogen. There is as much hydrogen provided to the fuel cell 1 as hydrogen consumed by the fuel cell 1.

However, there are parasitic phenomena within the fuel cell (cross-over): migration of nitrogen and water produced in the cathode. These species may pass through the membranes and end up in the anode. To discharge them, the valve located on the outlet duct 52 is opened from time to time. The hydrogen flow rate then allows discharging the undesirable nitrogen and water. It is then understood that a certain amount of hydrogen is lost in this operation. However, the amount of hydrogen lost in this supply mode remains much lower than the losses of hydrogen in the circulating mode.

A third mode is derived from the “circulating” mode and allows reinjecting at the inlet of the fuel cell 1 the hydrogen that leaves it and therefore reusing most of the hydrogen which is otherwise lost. This method is called “recirculation” method.

In operation of the fuel cell 1, the fuel stored in the hydrogen tank 50 circulates in the inlet duct 51 for the entry of the hydrogen into the fuel cell 1, enters the fuel cell 1, circulates in the fuel cell 1, in particular in the fuel circulation ducts 51A-51D, leaves the fuel cell 1 and circulates in the unconsumed hydrogen outlet duct 52.

In the embodiment of FIG. 5, the oxidant circulation circuit 30-33 includes an air compressor 30, a duct 31 for intaking air in the air compressor 30, an inlet duct 32 connecting the air compressor 30 and the fuel cell 1 and an outlet duct 33 of the fuel cell 1. The inlet duct 32 is connected to the inlet end plate 12 of the fuel cell 1, the outlet duct 33 is connected to the outlet end plate 11 of the fuel cell 1 and the air compressor is disposed between the duct 30 for intaking air in the air compressor 31 and the inlet duct 32.

In operation of the fuel cell 1, the oxidant circulates in the duct 31 for intaking air in the air compressor 30, passes in the air compressor 30, circulates in the inlet duct 32 connecting the air compressor 30 and the fuel cell 1, enters the fuel cell 1, circulates in the fuel cell 1, in particular in the oxidant circulation ducts 32A-32D, leaves the fuel cell 1 and circulates in the outlet duct 33.

In the embodiment of FIG. 5, the system 600 includes an electric circuit including a battery 40. The electric circuit may include an electric bus 4, connecting the battery 40 to electric converters, for example an electric converter 41 for the air compressor 30, an electric converter 42 for the fuel cell 1, an electric converter 43 for the pump 22 and an electric converter 44 for the heat exchanger 20 configured to heat the heat transfer fluid. The electric circuit includes electric contactors (or switches) 400-440 configured to allow connecting the electric bus 4 to the air compressor 30, to the fuel cell 1, to the pump 22, to the heat exchanger heat 20 configured to heat the heat transfer fluid and/or to the battery 40 or to allow isolating it therefrom.

It is understood that the electric converters and the electric contactors are optional. Where appropriate, they may be separate from each other or common. The converter 44 in particular is only an exemplary embodiment which assumes that the heating is done electrically; the heating may be envisaged by other modes.

The method 700 for controlling the system 600 will be described below.

The control method 700 includes a step 702 of preheating m sub-stacks 101, 102, 103 of the stack 10 of the fuel cell 1, m being greater than or equal to 1 and less than or equal to n, n being the number of intermediate plates 13 of the fuel cell 1, n being greater than or equal to 1.

When them sub-stacks 101, 102, 103 are at working temperature, a step 704 of producing energy in the m sub-stacks 101, 102, 103.

The control method 700 may include a step 706 of preheating p sub-stacks 101, 102, 103 of the stack 10 of the fuel cell 1 at least partially by means of the energy produced by the m sub-stacks 101, 102, 103, the p sub-stacks being separate from the m sub-stacks and p being greater than or equal to 1 and m+p being less than or equal to n+1. When the p sub-stacks are at working temperature, the control method 700 may include a step 708 of producing energy in the m+p sub-stacks.

In the control method 700, the energy produced by the m sub-stacks may be stored in the battery 40, which acts as an energy storage device and/or may be used to power auxiliary components of the system 600 and/or be used to provide energy to the external components connected to the system 600 and powered by the system 600.

The method 700 for controlling the system 600 will be described with reference to FIGS. 5-9, that is to say in one embodiment in which n is equal to 1, that is to say in which the fuel cell 1 includes a single intermediate plate 13 and two sub-stacks 101, 102 of the stack 10.

The control method 700 includes a step 702 of preheating the fuel cell 1, that is to say the sub-stack 101 in the embodiment of FIGS. 6-8. The step 702 of preheating the fuel cell 1 corresponds to the phase I of FIGS. 6-8.

In FIGS. 6-8, the control valves are represented in solid lines when they are closed, that is to say they do not allow fluid to pass, and in broken lines when they are open, that is to say they allow fluid to pass.

During the preheating step 702, the contactor 400 disposed between the electric bus 4 and the battery 40, the contactor 430 disposed between the electric converter 43 and the pump 22 and the contactor 440 disposed between the electric converter 44 and the heat exchanger 20 configured to heat the heat transfer fluid are closed. The three-way valve 23 is in a position such that the heat transfer fluid travels through the heat exchanger 20 configured to heat the heat transfer fluid.

The pump 22 drives the heat transfer fluid in the heat transfer fluid circulation circuit 20-25. The heat transfer fluid enters the heat exchanger 20 which heats the heat transfer fluid. The heated heat transfer fluid circulates in the inlet duct 24 for the entry of the heat transfer fluid into the fuel cell 1. The heat transfer fluid enters the fuel cell 1 through the inlet end plate 12, enters the duct 24A of the first sub-stack 101.

The valve 131 for controlling the intermediate plate 13 is closed and the valve 132 for controlling the intermediate plate 13 is open so that the heat transfer fluid may not flow into the duct 24C of the second sub-stack 102 and the heat transfer fluid circulates in the first sub-stack 101, that is to say the heat transfer fluid passes through the first sub-stack 101.

The valve 112 for controlling the outlet end plate 11 is closed and the valve 111 for controlling the outlet end plate is open so that the heat transfer fluid does not circulate in the second sub-stack 102, that is to say it does not pass through the second sub-stack 102. The heat transfer fluid then leaves the fuel cell 1 and circulates in the heat transfer fluid outlet duct 25 to go back to the pump 22 and the heat exchanger 20.

It is understood that the heat transfer fluid does not pass through the second sub-stack 102 so that the heating is mainly carried out in the first sub-stack 101.

During the preheating step 702, no reactant (oxidant and/or fuel) circulates in the fuel cell 1.

When the first sub-stack 101 of the fuel cell 1 is at working temperature of the fuel cell 1, the step 704 of producing energy in the first sub-stack 101 may start.

During the step 704 of producing energy in the first sub-stack 101, the contactor 410 disposed between the electric converter 41 and the air compressor 30 is closed so that the air compressor 30 supplies the fuel cell 1 with oxidant.

The oxidant circulates in the duct for intaking air 31 in the air compressor 30, passes in the air compressor 30, circulates in the inlet duct 32 connecting the air compressor 30 and the fuel cell 1, enters the fuel cell 1, circulates in first sub-stack 101 of the fuel cell 1, leaves the fuel cell 1 and circulates in the outlet duct 33.

The oxidant circulates in the fuel cell 1 in the following manner. The valve 135 for controlling the intermediate plate 13 is closed and the valve 136 for controlling the intermediate plate is open so that the oxidant which has entered the duct 32A of the first sub-stack 101 may not flow into the duct 32C of the second sub-stack 102 and the oxidant circulates in the first sub-stack 101, that is to say the oxidant passes through the first sub-stack 101 to pass through the control valve 136 and enter the duct 32D of the second sub-stack 102 and leaves the fuel cell 1 in the outlet duct 33, as illustrated in the phase II of FIG. 8.

The fuel circulates in the inlet duct 51 for the entry of the hydrogen into the fuel cell 1, enters the fuel cell 1, circulates in the first sub-stack 101 of the fuel cell 1, leaves the cell fuel 1 and circulates in the unconsumed hydrogen outlet duct 52.

The fuel circulates in the fuel cell 1 in the following manner. The valve 133 for controlling the intermediate plate 13 is closed and the valve 134 for controlling the intermediate plate 13 is open so that the oxidant which has entered the duct 51A of the first sub-stack 101 may not flow into the duct 51C of the second sub-stack 102 and the fuel circulates in the first sub-stack 101, that is to say the fuel passes through the first sub-stack 101 to pass through the control valve 134 and enter the duct 51D of the second sub-stack 102 and leave the fuel cell 1 in the unconsumed hydrogen outlet duct 52, as illustrated in the phase II of FIG. 7.

The contactor 420 of the electric converter 42 for the fuel cell 1 disposed between the first stack 101 of the fuel cell and the electric converter 42 is closed so that the first stack 101 of the fuel cell 1 is connected to the electric bus 4.

The first sub-stack 101 produces energy. The step of producing energy in the first sub-stack 101 corresponds to the phase I in FIG. 6 and the phase II of FIGS. 7-8.

When the production of energy in the first sub-stack 101 is greater than the consumption of the auxiliaries, such as the air compressor 30, the pump 22 and the heat exchangers 20, 21, the contactor 400 may remain closed in order to recharge the battery 40 or the contactor 400 may switch to the open position when the battery 40 is recharged. When the contactor 400 is open, the first sub-stack 101 supplies the auxiliaries. The first sub-stack 101 may also provide energy to the equipment external to the systems connected to the electric bus 4.

When the production of energy in the first sub-stack 101 is lower than the consumption of the auxiliaries, such as the air compressor 30, the pump 22 and the heat exchangers 20, 21, the contactor 400 may remain closed so that the battery 40 may compensate for the power demand of the auxiliaries.

When the production of energy in the first sub-stack 101 is in progress, the temperature in the first sub-stack 101 may increase and when a predetermined threshold is detected, the three-way valve 23 orients the heat transfer fluid coming from the fuel cell 1 towards the heat exchanger 21 configured to cool the heat transfer fluid. In the cooling mode of the fuel cell 1, the contactor 440 disposed between the electric converter 44 and the heat exchanger 20 configured to heat the heat transfer fluid is open.

When the production of energy in the first sub-stack 101 is not sufficient to meet the needs, the control method 400 may include a step 706 of preheating the second sub-stack 102 of the stack 10 of the fuel cell 1.

During the preheating step 706, the first sub-stack 101 produces energy and heat, as described previously and at least part of the energy and/or of the heat produced by the first sub-stack 101 is used to preheat the second sub-stack 102. For example, the energy produced by the first sub-stack 101 allows supplying the compressor 30, the pump 22 and the heat exchanger 20 configured to heat the heat transfer fluid. The heat produced by the first sub-stack 101 is transferred to the second sub-stack 102 via the heat transfer fluid which circulates first in the first sub-stack 101 then in the second sub-stack 102.

To preheat the second stack 102, as represented in the phase II of FIG. 6, the valve 112 for controlling the outlet end plate 11 is open and the valve 111 for controlling the outlet end plate is closed so that the heat transfer fluid circulates in the first sub-stack 101 and then in the second sub-stack 102, that is to say the heat transfer fluid passes through the first sub-stack 101 then the second sub-stack 102 then exits from the control valve 112 and travels through the duct 113 then leaves the fuel cell in the heat transfer fluid outlet duct 25 then goes back to the pump 22 and the heat exchanger 20.

It is understood that the step 706 of preheating the p sub-stacks is carried out while the step 704 of producing energy in the m sub-stacks is in progress. It is understood that the step 704 of producing energy in the m sub-stacks may be carried out without the step 706 of preheating the p sub-stacks being carried out (idle mode).

When the second sub-stack 102 is at working temperature, the control method 700 may include a step 708 of producing energy in the two sub-stacks 101, 102.

When the first sub-stack 101 and the second sub-stack 102 of the fuel cell 1 are at working temperature of the fuel cell 1, the step 708 of producing energy in the first sub-stack 101 and in the second sub-stack 102 may start.

In the cooling mode of the fuel cell 1, the contactor 430 disposed between the pump 22 and the electric bus 4 is closed and the contactor 440 disposed between the electric converter 44 and the heat exchanger 20 configured to heat the heat transfer fluid is open. The three-way valve 23 orients the heat transfer fluid coming from the fuel cell 1 towards the heat exchanger 21 configured to cool the heat transfer fluid.

The valve 111 for controlling the outlet end plate 11 is open, the valve 112 for controlling the outlet end plate 11 is closed, the valve 131 for controlling the intermediate plate 13 is open and the valve 132 for controlling the intermediate plate 13 is open so that the heat transfer fluid circulates in the first sub-stack 101 and in the second sub-stack 102, that is to say the heat transfer fluid passes through the first sub-stack 101 and the second sub-stack stack 102 in parallel (and no longer in series as in the step of preheating the second sub-stack 102) to exit through the control valve 111 and leave the fuel cell in the heat transfer fluid outlet duct 25 to go back to the pump 22 and the heat exchanger 20. The heat transfer fluid passes through the first sub-stack 101 of the duct 24A towards the duct 24B and the second sub-stack 102 of the duct 24C towards the duct 24D, as illustrated in the phase III of FIG. 6.

During the step 708 of producing energy in the first sub-stack 101 and the second sub-stack 102, the contactor 410 disposed between the electric converter 41 and the air compressor 30 is closed so that the air compressor 30 supplies the fuel cell 1 with oxidant.

The oxidant circulates in the duct 31 for intaking air in the air compressor 30, passes in the air compressor 30, circulates in the inlet duct 32 connecting the air compressor 30 and the fuel cell 1, enters the fuel cell 1, circulates in the first sub-stack 101 and the second sub-stack 102 of the fuel cell 1, leaves the fuel cell 1 and circulates in the outlet duct 33.

The oxidant circulates in the fuel cell 1 in the following manner. The valve 135 for controlling the intermediate plate 13 is open and the valve 136 for controlling the intermediate plate is open so that the oxidant which has entered the duct 32A of the first sub-stack 101 flows into the duct 32C of the second sub-stack 102 and the oxidant circulates in the first sub-stack 101 and in the second sub-stack 102, that is to say the oxidant passes through the first sub-stack 101 by passing from the duct 32A to the duct 32B of the first sub-stack 101 and passes through the second sub-stack 102 by passing from the duct 32C to the duct 32D to leave the fuel cell 1 in the outlet duct 33, as illustrated in the phase III of FIG. 8.

The fuel circulates in the inlet duct 51 for the entry of the hydrogen into the fuel cell 1, enters the fuel cell 1, circulates in the first sub-stack 101 and in the second sub-stack 102 of the fuel cell 1, leaves the fuel cell 1 and circulates in the unconsumed hydrogen outlet duct 52.

The fuel circulates in the fuel cell 1 in the following manner. The valve 133 for controlling the intermediate plate 13 is open and the valve 134 for controlling the intermediate plate is open so that the fuel which has entered the duct 51A of the first sub-stack 101 flows into the duct 51C of the second sub-stack 102 and the fuel circulates in the first sub-stack 101 and in the second sub-stack 102, that is to say the fuel passes through the first sub-stack 101 by passing from the duct 51A to the duct 51B of the first sub-stack 101 and passes through the second sub-stack 102 by passing from the duct 51C to the duct 51D to leave the fuel cell 1 in the unconsumed hydrogen outlet duct 52, as illustrated in the phase III of FIG. 7.

The contactors 420, 421 of the electric converter 42 for the fuel cell 1 disposed between the electric converter 42 and respectively the first sub-stack 101 and the second sub-stack 102 of the fuel cell 1 are closed so that the first sub-stack 101 and the second sub-stack 102 of the fuel cell 1 are connected to the electric bus 4.

The first sub-stack 101 and the second sub-stack 102 produce energy. The step 708 of producing energy in the first sub-stack 101 and the second sub-stack 102 corresponds to the phase III of FIGS. 6-8.

It is understood that when the demand is reduced, it is possible to stop the production of energy in the second sub-stack 102.

When the demand increases again, it is possible to produce more energy again by producing energy in the first sub-stack 101 and in the second sub-stack 102.

Of course, the control method 700 is not limited to a fuel cell 1 with an intermediate plate 13. The control method 700 may be applied in a similar way to a fuel cell 1 including more than a single intermediate plate 13. Also, depending on the number of intermediate plates 13, it is possible to preheat, during the step 702 of preheating the m sub-assemblies or during the step 706 of preheating the p sub-stacks, more than one subset at a time.

It is understood that it is possible to preheat each sub-stack or not on demand, depending on the need.

Similarly, it is understood that each sub-stack may produce energy or not on demand, depending on the need.

Although the present disclosure has been described with reference to a specific exemplary embodiment, it is obvious that various modifications and changes may be made to these examples without departing from the general scope of the invention as defined by the claims. Furthermore, individual characteristics of the various embodiments discussed may be combined in additional embodiments. Accordingly, the description and the drawings should be considered in an illustrative rather than restrictive sense. The same applies to the heating means 20 which may not be an electric heating means.

1. A fuel cell comprising:
a stack of membrane/electrodes assemblies including an ion-conductive electrolyte disposed between an anode and a cathode, two adjacent assemblies being separated by a bipolar plate, the stack including a first and a second end,
an inlet end plate disposed at the first end of the stack and an outlet end plate disposed at the second end of the stack,
n intermediate plates disposed in the stack between the inlet end plate and the outlet end plate to form n+1 sub-stacks of the stack, n being greater than or equal to 1,
ducts for circulating a heat transfer fluid, an oxidant and a fuel in the fuel cell, the circulation ducts passing in the inlet end plate, the outlet end plate and the n intermediate plates,
valves for controlling the heat transfer fluid in the circulation ducts of the outlet end plate and valves for controlling the heat transfer fluid, the oxidant and the fuel in the circulation ducts of the n intermediate plates, the control valves being configured to allow the circulation of the heat transfer fluid, the oxidant and the fuel in m sub-stacks of the stack, m being greater than or equal to 1 and less than or equal to n.

2. The fuel cell according to claim 1, wherein the ducts for circulating the heat transfer fluid for the preheating of the fuel cell and for the cooling of the fuel cell are combined.

3. The fuel cell according to claim 1, wherein the ion-conductive electrolyte is a proton exchange membrane.

4. The fuel cell according to claim 3, wherein the proton exchange membrane is a proton exchange membrane high temperature.

5. The fuel cell according to claim 1, wherein the valves for controlling at least one of the n intermediate plates are external to the intermediate plate.

6. A system comprising a fuel cell according to claim 1, a circuit for circulating the heat transfer fluid, a circuit for circulating the fuel, a circuit for circulating the oxidant and an electric circuit comprising a device for storing energy.

7. The system according to claim 6, wherein the heat transfer fluid circulation circuit comprises a heat exchanger configured to cool the heat transfer fluid and a heat exchanger configured to heat the heat transfer fluid.

8. A method for controlling a system according to claim 6, the method comprising the following steps:
a step of preheating m sub-stacks of the stack of the fuel cell;
when the m sub-stacks are at working temperature, a step of producing energy in the m sub-stacks.

9. The control method according to claim 8, comprising:
a step of preheating p sub-stacks of the stack of the fuel cell at least partially by means of the energy and/or the heat produced by the m sub-stacks, the p sub-stacks being separate from them sub-stacks and p being greater than or equal to 1 and m+p being less than or equal to n+1,
when the p sub-stacks are at working temperature, a step of producing energy in the m+p sub-stacks.

10. The control method according to claim 8, wherein the energy produced by the m sub-stacks is stored in the energy storage device and/or is used to power auxiliary components of the system and/or is used to power components external to the system.
